(19) United States
(12) Patent Application Publication
(10) Pub. No.: US 2023/0169615 A1
(43) Pub. Date: Jun. 1, 2023

(54) Real Estate Associated Tokens

(71) Applicants: Curtis Hutten, Laguna Beach, CA (US); Robert Fish, Irvine, CA (US)

(72) Inventors: Curtis Hutten, Laguna Beach, CA (US); Robert Fish, Irvine, CA (US)

(21) Appl. No.: 17/985,545

(22) Filed: Nov. 11, 2022

Related U.S. Application Data
(60) Provisional application No. 63/283,436, filed on Nov. 27, 2021.

(51) Int. Cl. G06Q 50/16; G06Q 30/06; G06F 21/10; G06Q 20/38

(52) U.S. Cl. CPC G06Q 50/16; G06Q 30/0641; G06F 21/10; G06Q 20/389

(57) ABSTRACT

Influencers utilize their fame to create demand for items of off-world real property, and utilize distributed ledger technology to acknowledge ownership of such off-world real property. The off-world real property preferably comprises heavenly stars or groupings of heavenly stars. Initial purchase prices can be based upon any suitable characteristic, including for star size, brightness, color, estimated age, visible hemisphere, name, and distance from Earth.

This application claims priority to U.S. provisional application having Ser. No. 63/283,436 filed on Nov. 27, 2021. This and all other extrinsic materials discussed herein are incorporated by reference in their entirety. Where a definition or use of a term in a reference that is incorporated by reference is inconsistent or contrary to the definition of that term provided herein, the definition of that term provided herein applies and the definition of that term in the reference does not apply.

### FIELD OF THE INVENTION

The field of the invention is use of distributed ledger technology to establish and manage ownership of off-world real estate.

### BACKGROUND

Property is anything that society recognizes as property. Perhaps the most basic form of recognition derives from physical possession, including for example something that can be held in one's hand, such as a gold coin, a jewel, a bearer bonds, a dollar bills, and even a physical ticket invitation to an event. Physical possession, of course, can be established by both physically holding something, and or preventing others from accessing the thing. Such notorious possession is often described with respect to physically accessible real estate, where an owner maintains ownership by preventing others from walking across or using the owned land, building, from extracting minerals from the ground, and so forth.

Property can also be ephemeral, broadly including non-physical rights. This includes the various forms of intellectual property, i.e., trademarks, copyrights, and trade secrets. Ephemeral property also includes legal rights, such as personal rights granted by a constitution, or by various laws.

Regardless of the type of property, valuation of property is determined by whatever the highest bidder is willing to pay for it. This implies that for property to have a recognized value, there must be a mechanism for valuing the property. Perhaps the most common valuation mechanisms are marketplaces, whether public or private. Other valuation mechanisms include court systems, such as where a plaintiff is awarded a sum of money for having a civil right taken away.

Whether by a marketplace, court of other system, valuation is commonly related to demand and scarcity. A house is functional in that an individual can live in the house, and the housing supply is limited. Precious metals are functional as currency, in jewelry, and in manufacturing of various electronics and other goods, but also because precious metals are limited in supply. Even things that have no function at all can value because of speculation. For example, the price of a nominally worthless NFT can explode precisely because it is unique, and therefore has a supply of only a single item. Each subsequent buyer purchases primarily in the hope of re-selling the NFT to someone else at an ever higher price. Scarcity, however, doesn't require uniqueness. Even though bitcoins are fungible, they can have a high prices merely because there are a limited number of bitcoins available on the market at any given time, and there is a high demand.

In a complex society, some form of publicly acknowledged recordation is needed to establish which entities own which properties. For example, ownership of real property is often recorded in a publicly accessible records of a county recorder's office, and ownership of money currency is often recorded on a ledger at a government recognized banking institution. More recently, distributed ledger technology has been used to establish and maintain ownership, with the distributed nature of the technology establishing the requisite public recognition.

Interestingly, although distributed ledger technology has been applied to virtual goods (e.g., crypto currencies and NFTs) and virtual spaces (in various video games), and even physically accessible real estate (via smart contracts), it has not been applied to off-world real estate. The reasons for this are not clear, but possibly involve the lack of demand causes by lack of functionality in the real world or a video game, and the perceived unlimited supply of off-world real estate.

There have been registration systems over the years in which a person can purportedly buy and name a star. The registrant then adds that information to a registry. Examples include https://cosmonova.org/ and https://starregister.org. The main problems with those systems are that (1) they have no leaders that would create demand for such names; (2) they have no realistic re-sale marketplace for resale that would establish pricing, and (3) their registries are entirely controlled by the owners of the registries, and therefore have no public credibility.

What is still needed are systems and methods for establishing demand, marketplace, and publicly acknowledged recordation of ownership of off-world real estate.

### BRIEF DESCRIPTION OF THE DRAWING

FIG. 1 is a flowchart showing aspects of the inventive subject matter.

### SUMMARY OF THE INVENTION

The inventive subject matter provides apparatus, systems and methods in which influencers utilize their fame to create demand for items of off-world real estate, and utilize distributed ledger technology to acknowledge ownership of such off-world real estate.

Various objects, features, aspects and advantages of the inventive subject matter will become more apparent from the following description of preferred embodiments.

It should be noted that while the following description is drawn to a computer/server based work package processing system, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

### DETAILED DESCRIPTION

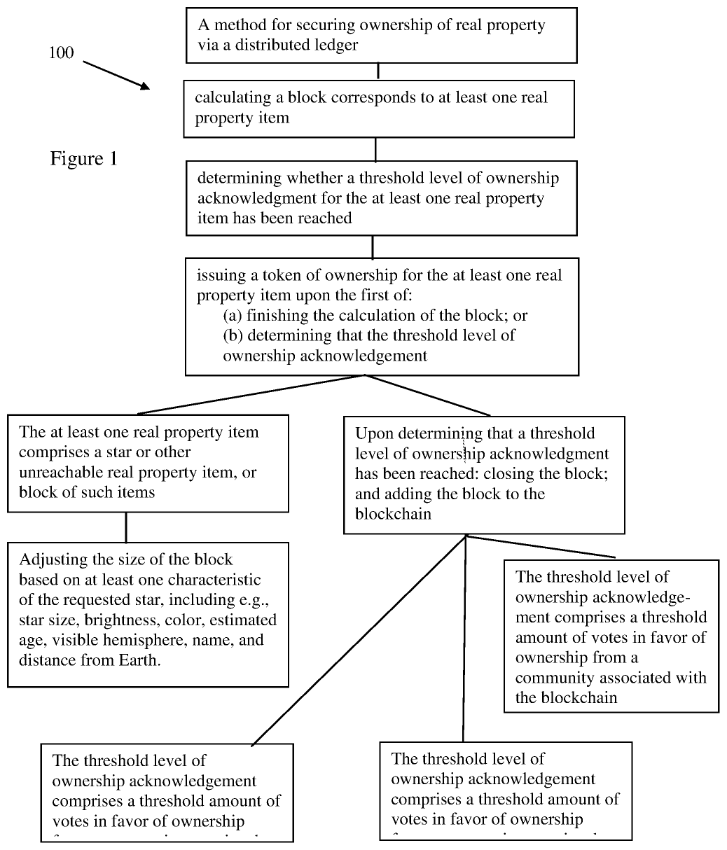

In FIG. 1, a social medial or other influencer engages in a presentation in which items of celestial real estate are offered for sale or purchase. Sales and purchase transactions can advantageously be maintained by one or more blockchain or other distributed ledger technologies.

Presentations are preferably distributed in a live fashion, but in other embodiments can additionally or alternatively be accessed as a pre-recorded presentation.

Presentation preferably involve rendering of a new song, or other activity intended to engage the audience. In some embodiments, the audience is limited, possibly even with audience participation being limited to paid participants.

Also in preferred embodiments, audience participants are shown a live or near live graphic that depicts recent purchase pricing of the items being sold. Audience participants are preferably shown a link for buying and selling the items.

The items of celestial real estate offered for sale are contemplated to include the approximately 1.8 billion known stars, and approximately 2000 known planets. Several thousand visible stars have common names, which often differ from country to country. Ideally, however, each of the stars sold/purchased using the contemplated methods are recorded in the one or more blockchain or other distributed ledger technologies using a systematic naming convention. Examples of systematic naming conventions are described in, including the Bayer and Flamsteed naming systems, described at https://www.pas.rochester.edu/˜blackman/ast104/naming.html.

As mentioned above, the known star registration systems (1) have no leaders that would create demand for such names; (2) have no realistic re-sale marketplace for resale that would establish pricing, and (3) are entirely controlled by the owners of the registries, and therefore have no public credibility. The inventive systems and methods described herein resolve each of the defects. Use of social media and other influencers automatically triggers the interest of thousands, and in many cases millions of followers. Using a publicly accessible distributed ledger system automatically provides a realistic marketplace, as well as public credibility.

In general demand, marketplace, and publicly acknowledged recordation of ownership of off-world real estate items, can be established by an influencer engaging in an event at which tokens representing a limited number of the off-world real estate items are marketed, and utilization of a distributed ledger is used to manage ownership of the tokens.

In some embodiments the tokens are offered directly at the event, and in other embodiments, some of all of the marketed tokens are offered at another site.

To gain excitement and hopefully a fast rise in the price of the tokens being marketed, the can advantageously provide for sale less than 50% of the tokens at the event. In some embodiments the amount of tokens offered is less than 10%, less than 5%, or even less than 1%.

In some, and likely in many embodiments, an entity will acquire a percentage of the tokens as a fee for arranging to have the tokens to be placed on the distributed ledger.

Several aspects of customizing NFTs are known, and it is further contemplated that the influencer or someone else, or even a computer, could can customize one or more of the tokens. See e.g., https://www.cryptocurrencyexchangescript.com/nft-development-services.

In preferred embodiments, one or more graphics will be displayed at the event, depicting aspects of sales of at least some of the tokens. Contemplated aspects being displayed include prices of tokens, and number of participants involved in purchasing of the tokens.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of using distributed ledger to establish and manage ownership of real property, comprising:
calculating, by at least one computer, a block for a blockchain, wherein the block corresponds to at least one real property item;
while the at least one computer is calculating the block, determining, by the computing device, whether a threshold level of ownership acknowledgment for the at least one real property item has been reached;
issuing a token of ownership for the at least one real property item upon the first of:
(a) finishing the calculation of the block; or
(b) determining that the threshold level of ownership acknowledgement

2. The method of claim 1, wherein the at least one real property item comprises at least one unreachable real property item.

3. The method of claim 2, wherein the at least one unreachable real property item comprises at least one star.

4. The method of claim 3, wherein the at least one unreachable property item comprises a plurality of stars and wherein each individual item of information within the block comprises an individual star within the plurality of stars.

5. The method of claim 3, further comprising:
receiving a request for purchase of a star from the at least one star;
determining the size of the requested star; and
adjusting the size of the block based on at least one characteristic of the requested star.

6. The method of claim 5, wherein the at least one characteristic comprises at least one of a star size, a brightness, a color, an estimated age, a visible hemisphere, a name, and a distance from Earth.

7. The method of claim 5, further comprising determining, by the at least one computer, a price for the star based on the size of the block.

8. The method of claim 1, further comprising, upon determining that a threshold level of ownership acknowledgment has been reached:
closing, by the at least one computer, the block; and
adding, by the at least one computer, the block to the blockchain.

9. The method of claim 1, wherein the threshold level of ownership acknowledgment comprises a threshold amount of votes in favor of ownership from a community associated with the blockchain.

10. The method of claim 1, further comprising destroying, by the at least one computer, the token of ownership upon the destruction of the at least one real property item.

11. A method for establishing demand, marketplace, and publicly acknowledged recordation of ownership of off-world real estate items, comprising:
an influencer engaging in an event at which tokens representing a limited number of the off-world real estate items are marketed; and
a distributed ledger is used to manage ownership of the tokens.

12. The method of claim 11, further comprising the influencer marketing less than 50% of the tokens at the event.

13. The method of claim 11, further comprising the influencer marketing less than 10% of the tokens at the event.

14. The method of claim 11, further comprising an entity acquiring a percentage of the tokens as a fee for arranging to have the tokens to be placed on the distributed ledger.

15. The method of claim 11, further comprising the influencer customizing one or more of the tokens.

16. The method of claim 11, further comprising a purchaser of an individual one of the tokens priori to re-selling the customized token.

17. The method of claim 11, further comprising displaying a graphic at the event, the graphic depicting prices of at least some of the tokens.

18. The method of claim 11, further comprising displaying a graphic at the event, the graphic depicting number of participants involved in purchasing of the tokens.
